(19) United States
(12) Patent Application Publication
(10) Pub. No.: US 2005/0276588 A1
(43) Pub. Date: Dec. 15, 2005

(54) Lens driving mechanism and image pickup device

(75) Inventor: Takuya Tsutsumi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/139,698

(22) Filed: May 31, 2005

(30) Foreign Application Priority Data
Jun. 9, 2004 (JP) 2004-171095

(51) Int. Cl. G03B 17/00

(52) U.S. Cl. 396/55

(57) ABSTRACT

A lens driving mechanism for eccentrically driving at least one lens or lens subunit, hereunder called a correcting lens, in a lens system constituting a taking lens unit in a plane perpendicular to an optical axis direction includes an electro-mechanical conversion element and a link mechanism. The electro-mechanical conversion element is fixedly disposed at a lens barrel where the taking lens unit is disposed, and is mechanically deformed by an application of a voltage. The link mechanism increases the mechanical deformation of the electro-mechanical conversion element and transmits the increased mechanical deformation to the correcting lens, and is disposed around the correcting lens at the outer side of an effective diameter of the correcting lens when viewed in the optical axis direction.

### CROSS REFERENCES TO RELATED APPLICATIONS

The present invention contains subject matter related to Japanese Patent Application JP 2004-171095 filed in the Japanese Patent Office on Jun. 9, 2004, the entire contents of which are incorporated herein by reference.

### BACKGROUND OF THE INVENTION

1. Field of the Invention

The present invention relates to a novel lens driving mechanism. More specifically, the present invention relates to a technology which uses a lens driving mechanism suitable for an optical camera movement correcting mechanism mounted in, for example, a video camera or a digital still camera and which can reliably increase to a required stroke a very small displacement of an electro-mechanical converting element (such as a piezoelectric element) and transmit the increased displacement to a lens.

2. Description of the Related Art

The optical camera movement correcting mechanism detects a camera movement in a direction perpendicular to an optical axis with a sensor and shifts a correcting lens perpendicularly to the optical axis so as to correct the amount of movement.

A voice coil motor, such as that disclosed in Japanese Unexamined Patent Application Publication No. 7-98470, is known to be used as a drive source for shifting the correcting lens.

FIG. 8 is a schematic view of a lens barrel including a camera movement correcting mechanism using a voice coil. The lens barrel includes a plurality of lens units GR and a photoelectric conversion element IMG, which are disposed in a row on an optical axis z-z. Of the plurality of lens units GR, the lens unit GR3 acts as a correcting lens and can shift perpendicularly to the optical axis z-z.

Referring to FIGS. 9 and 10, the structure for correcting camera movement will be described. A correcting lens (unit) GR3 is held by a holding frame a which is capable of moving in a guide shaft direction by guide shafts b and b. A coil c is mounted to the holding frame a and generates a force by the magnetic force from magnets d and d, disposed at respective sides of the coil and by an electrical current flowing through the coil c in order to drive the holding frame a in the direction of the guide shafts b and b. Although not shown, a sensor for detecting the position of the correcting lens unit GR3 is disposed. The electrical current in the coil c is controlled so that the correcting lens unit GR3 can be driven to a target location while its current position is detected.

FIG. 11 is a schematic view showing a state in which a lens barrel e is tilted by a camera movement and the correcting lens unit GR3 is shifting to a location where it can cancel the camera movement. When the lens barrel e is tilted by the camera movement, the correcting lens unit GR3 is shifted perpendicularly to the optical axis z-z and along the guide shafts b and b in order adjust refraction of light, so that blurring does not occur at an image plane (see the solid line arrow in FIG. 11).

### SUMMARY OF THE INVENTION

Accordingly, although the camera movement is compensated for by shifting the correcting lens (unit) G3, the above-described method for correcting camera movement has several problems.

First, when the coil c, serving as a drive source, is not energized, the correcting lens (unit) GR3 moves in the gravitational direction, as a result of which the correcting lens (unit) GR3 can no longer be held on the optical axis z-z. Therefore, during shooting, it is difficult to hold the correcting lens (unit) GR3 at a predetermined position when the coil c is not energized, thereby hindering a reduction in power consumption.

To overcome this problem, a method illustrated in FIG. 12 has been proposed. In this method, the correcting lens (unit) GR3 is held by coil springs f in order to restrict power consumption by setting the coil c in an unenergized state during shooting when the camera movement correction function is not used. However, this method also has a problem in that, in order to stabilize the correcting lens (unit) GR3 at a point where the gravitational force and the spring force are in equilibrium, as shown in FIG. 13, when the coil c is not energized, the correcting lens (unit) GR3 is shifted in the gravitational direction, causing the equilibrium point to differ depending upon the posture of a camera.

Therefore, when a user starts to use the camera movement correction function, the position of the correcting lens (unit) GR3 instantaneously moves onto the optical axis from the position where the gravitational force and the spring force were at equilibrium when the coil c had not been energized. Consequently, when the user starts to use the camera movement function, framing instantaneously changes, which is not desirable for the user.

Accordingly, it is desirable to provide a structure which rarely requires energization for maintaining a correcting lens on an optical axis during shooting when a camera movement correction function is not used, which is compact, and which can precisely shift the position of the correcting lens.

A lens driving mechanism according to an embodiment of the present invention includes an electro-mechanical conversion element and a link mechanism. The electro-mechanical conversion element is fixedly disposed at a lens barrel where the taking lens unit is disposed and is mechanically deformed by an application of a voltage. The link mechanism increases the mechanical deformation of the electro-mechanical conversion element and transmits the increased mechanical deformation to the correcting lens, and is disposed around the correcting lens at the outer side of an effective diameter of the correcting lens when viewed in the optical axis direction.

A image pickup device according to another embodiment of the present invention includes a taking lens unit, an image pickup element converting an optical image formed by the taking lens unit into an electrical signal, and a lens driving mechanism for eccentrically driving at least one lens or lens subunit, hereunder called a correcting lens, in a lens system constituting the taking lens unit in a plane perpendicular to an optical axis direction. The lens driving mechanism includes an electro-mechanical conversion element and a link mechanism. The electro-mechanical conversion element is fixedly disposed at a lens barrel where the taking lens unit is disposed and is mechanically deformed by an application of a voltage. The link mechanism increases the mechanical deformation of the electro-mechanical conversion element and transmits the increased mechanical deformation to the correcting lens, and is disposed around the correcting lens at the outer side of an effective diameter of the correcting lens when viewed in the optical axis direction.

Therefore, according to the embodiments of the present invention, while the electro-mechanical conversion element is not energized, the correcting lens is held on the optical axis and the position of the correcting lens is precisely shifted.

The lens driving mechanism according to the embodiment of the present invention eccentrically drives at least one lens or lens subunit, hereunder called a correcting lens, in a lens system constituting the taking lens unit in a plane perpendicular to an optical axis direction. As mentioned above, it includes an electro-mechanical conversion element and a link mechanism. The electro-mechanical conversion element is fixedly disposed at a lens barrel where the taking lens unit is disposed and is mechanically deformed by an application of a voltage. The link mechanism increases the mechanical deformation of the electro-mechanical conversion element and transmits the increased mechanical deformation to the correcting lens, and is disposed around the correcting lens at the outer side of an effective diameter of the correcting lens when viewed in the optical axis direction.

As mentioned above, the image pickup device according to the another embodiment of the present invention includes a taking lens unit, an image pickup element converting an optical image formed by the taking lens unit into an electrical signal, and a lens driving mechanism for eccentrically driving at least one lens or lens subunit, hereunder called a correcting lens, in a lens system constituting the taking lens unit in a plane perpendicular to an optical axis direction. The lens driving mechanism includes an electro-mechanical conversion element and a link mechanism. The electro-mechanical conversion element is fixedly disposed at a lens barrel where the taking lens unit is disposed and is mechanically deformed by an application of a voltage. The link mechanism increases the mechanical deformation of the electro-mechanical conversion element and transmits the increased mechanical deformation to the correcting lens, and is disposed around the correcting lens at the outer side of an effective diameter of the correcting lens when viewed in the optical axis direction.

Therefore, according to the embodiments of the present invention, since the deformation of the electro-mechanical conversion element is increased and transmitted in order to drive the correcting lens, the electro-mechanical conversion element is not deformed during the unenergized state, so that the position of the correcting lens is maintained by the electro-mechanical conversion element in the unenergized state. Consequently, if the position of the correcting lens is adjusted so that it is on the optical axis when the electro-mechanical conversion element is not deformed, it is rarely necessary to perform energization for holding the correcting lens on the optical axis during shooting when a camera movement correction function is not used.

Since the amount of deformation of the electro-mechanical conversion element varies according to an applied voltage value, a very small amount of deformation can be controlled, so that the position of the correcting lens can be precisely shifted.

Since the link mechanism which increases the deformation of the electro-mechanical conversion element and which transmits it to the correcting lens is disposed around the correcting lens when viewed in the optical axis direction at the outer side of the effective diameter of the correcting lens, the lens driving mechanism according to the embodiment can be disposed in a very narrow space, thereby restricting an increase in the size of the lens barrel.

The image pickup device including the lens driving mechanism having the aforementioned advantages can provide a high-quality image formed after correcting camera movement, is small, and can save power.

A lens driving mechanism according to still another embodiment of the present invention for eccentrically driving at least one lens or lens subunit, hereunder called a correcting lens, in a lens system constituting a taking lens unit in a plane perpendicular to an optical axis direction includes a stationary base fixedly disposed at a lens barrel where the taking lens unit is disposed, a first movable base movable in one direction perpendicular to the optical axis direction with respect to the stationary base, and a second movable base movable perpendicularly to the optical axis direction and the one direction with respect to the first movable base. The stationary base and the first movable base each have an electro-mechanical conversion element and a link mechanism disposed thereat, each electro-mechanical conversion element being fixedly disposed at its associated base and being mechanically deformed by an application of a voltage, each link mechanism being disposed around the correcting lens at the outer side of an effective diameter of the correcting lens when viewed in the optical axis direction and increasing and transmitting the mechanical deformation of its associated electro-mechanical conversion element. The mechanical deformation of the electro-mechanical conversion element disposed at the stationary base is transmitted to the first movable base by the link mechanism disposed at the stationary base. The mechanical deformation of the electro-mechanical conversion element disposed at the first movable base is transmitted to the second movable base by the link mechanism disposed at the first movable base. The second movable base holds the correcting lens.

An image pickup device according to still another embodiment of the present invention image pickup device includes a taking lens unit, an image pickup element converting an optical image formed by the taking lens unit into an electrical signal, and a lens driving mechanism for eccentrically driving at least one lens or lens subunit, hereunder called a correcting lens, in a lens system constituting the taking lens unit in a plane perpendicular to an optical axis direction. The lens driving mechanism includes a stationary base fixedly disposed at a lens barrel where the taking lens unit is disposed, a first movable base movable in one direction perpendicular to the optical axis direction with respect to the stationary base, and a second movable base movable perpendicularly to the optical axis direction and the one direction with respect to the first movable base. The stationary base and the first movable base each have an electro-mechanical conversion element and a link mechanism disposed thereat, each electro-mechanical conversion element being fixedly disposed at its associated base and being mechanically deformed by an application of a voltage, each link mechanism being disposed around the correcting lens at the outer side of an effective diameter of the correcting lens when viewed in the optical axis direction and increasing and transmitting the mechanical deformation of its associated electro-mechanical conversion element. The mechanical deformation of the electro-mechanical conversion element disposed at the stationary base is transmitted to the first movable base by the link mechanism disposed at the stationary base. The mechanical deformation of the electro-mechanical conversion element disposed at the first movable base is transmitted to the second movable base by the link mechanism disposed at the first movable base. The second movable base holds the correcting lens.

Therefore, according to these embodiments of the present invention, the correcting lens can be shifted in all directions perpendicular to the optical axis.

During shooting when the camera movement correction function is not used, energization for holding the correcting lens on the optical axis is rarely required.

Since the amount of deformation of each electro-mechanical conversion element varies according to an applied voltage value, a very small amount of deformation can be controlled, so that the position of the correcting lens can be precisely shifted.

Since each link mechanism which increases the deformation of its associated electro-mechanical conversion element and which transmits it to the correcting lens is disposed around the correcting lens when viewed in the optical axis direction at the outer side of the effective diameter of the correcting lens, the lens driving mechanism according to the embodiment can be disposed in a very narrow space, thereby restricting an increase in the size of the lens barrel.

The image pickup device including the lens driving mechanism having the aforementioned advantages can provide a high-quality image formed after correcting camera movement, is small, and can save power.

In each of the embodiments, the link mechanism or each link mechanism may include at least one lever including a first lever and having a fulcrum, a power point, and an application point, and the mechanical deformation of the electro-mechanical conversion element connected to the power point of the first lever or the mechanical deformation of each electro-mechanical conversion element connected to the power point of its associated first lever may be increased and transmitted to the application point of the first lever or the application point of its associated first lever. Therefore, the link mechanism or each link mechanism which increases and transmits the deformation of the electro-mechanical conversion element or its associated electro-mechanical conversion element can be simplified.

In each of the embodiments, the at least one lever of the link mechanism or each link mechanism may further include a second lever having a fulcrum, a power point, and an application point, the power point of the second lever or each second lever may be connected to the application point of the first lever or its associated first lever, and the first lever and the second lever or each first lever and its associated second lever may be disposed opposite to each other with the correcting lens being disposed therebetween when viewed in the optical axis direction. Therefore, the deformation of the electro-mechanical conversion element or each electro-mechanical conversion element can be easily increased and transmitted, and the link mechanism or each link mechanism can be compactly disposed around the correcting lens and without affecting the operation of the correcting lens.

In each of the embodiments, members of the link mechanism or each link member may be integrally disposed and may be connected with an integral hinge corresponding to a thin connecting portion of the members of the link mechanism or its associated link mechanism. Therefore, rattling caused by a difference between the diameter of a hole and the diameter of a shaft as that in a rotatable connecting unit including a hole and a shaft rarely occurs, so that the deformation of the electro-mechanical conversion element or each electro-mechanical conversion element is precisely transmitted.

In each of the embodiments, the link mechanism or each link mechanism may further include a link linking the first lever or its associated first lever and the electro-mechanical conversion element or its associated electro-mechanical conversion element, and the link and the power point of the first lever or each link and the power point of its associated first lever may be integrally disposed and may be connected with a thin integral hinge. Therefore, rattling caused by a difference between the diameter of a hole and the diameter of a shaft as that in a rotatable connecting unit including a hole and a shaft rarely occurs, so that the amount of displacement is precisely transmitted from the first lever to the second lever.

In each of the embodiments, the link mechanism or each link mechanism may further include a first link linking the first lever and the electro-mechanical conversion element or its associated electro-mechanical conversion element and a second link linking the application point of the first lever or its associated first lever and the power point of the second lever or its associated second lever, and the first link and the power point of the first lever or each first link and the power point of each first lever, the second link and the application point of the first lever or each second link and the application point of its associated first lever, and the second link and the power point of the second lever or each second link and the power point of its associated second lever are integrally disposed and are connected with thin integral hinges, respectively. Therefore, rattling caused by a difference between the diameter of a hole and the diameter of a shaft as that in a rotatable connecting unit including a hole and a shaft rarely occurs, so that the amount of deformation of the electro-mechanical conversion element or each electro-mechanical conversion element is precisely increased and transmitted to the second lever via the first lever.

### BRIEF DESCRIPTION OF THE DRAWINGS

FIG. 1, along with FIGS. 2 to 6, shows a lens driving mechanism according to an embodiment of the present invention, and is a perspective view of the entire lens driving mechanism;

FIG. 2 is a perspective view of the lens driving mechanism shown in exploded form in accordance with each block;

FIG. 3 is a perspective view of the lens driving mechanism showing each block in exploded form;

FIG. 4 is a front view of a stationary block;

FIG. 5 is a front view of a first movable block;

FIG. 6A illustrates an operation in an unenergized state;

FIG. 6B illustrates an operation in an energized state;

FIG. 7 is a block diagram of an image pickup device in accordance with an embodiment of the present invention;

FIG. 8, along with FIGS. 9 to 11, illustrates a problem of a related camera movement correcting mechanism, and is a schematic view of its structure shown in cross section along an optical axis;

FIG. 9 is a rear view thereof;

FIG. 10 is a side view thereof;

FIG. 11 is a sectional view along the optical axis of the related camera movement correcting mechanism that is correcting camera movement;

FIG. 12, along with FIG. 13, illustrates another problem of the related camera movement correcting mechanism, and shows a correcting lens being maintained at its neutral state by energization;

FIG. 13 shows an unenergized state.

### DESCRIPTION OF THE PREFERRED EMBODIMENTS

A lens driving mechanism and an image pickup device according to preferred embodiments of the present invention will hereunder be described with reference to the attached drawings.

A lens driving mechanism will be described.

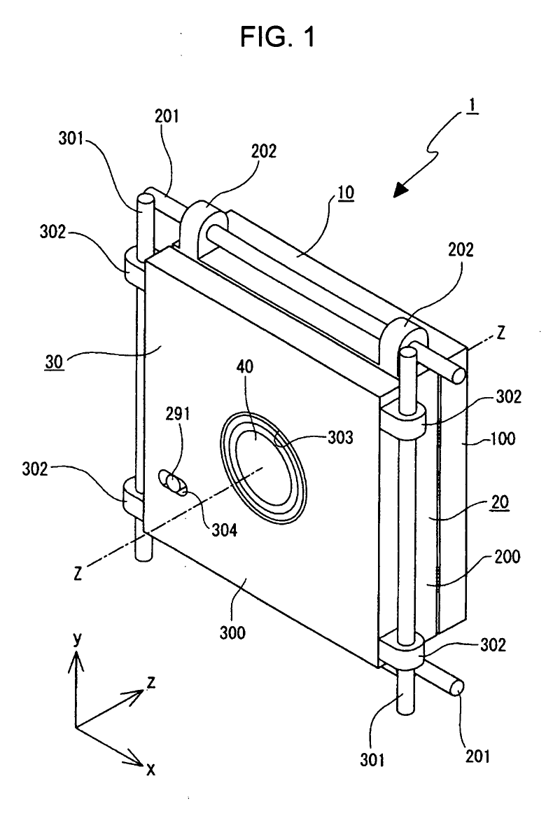

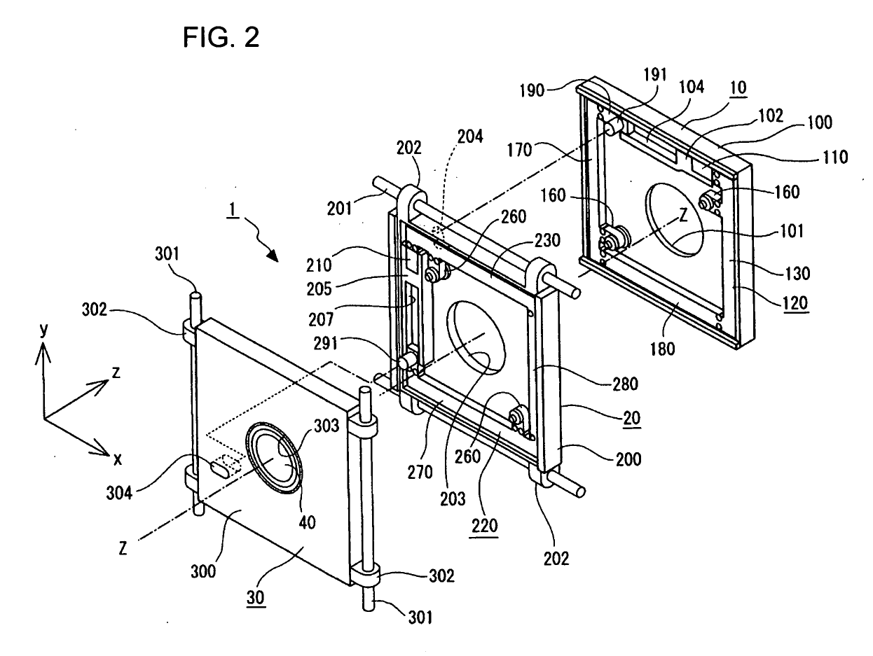

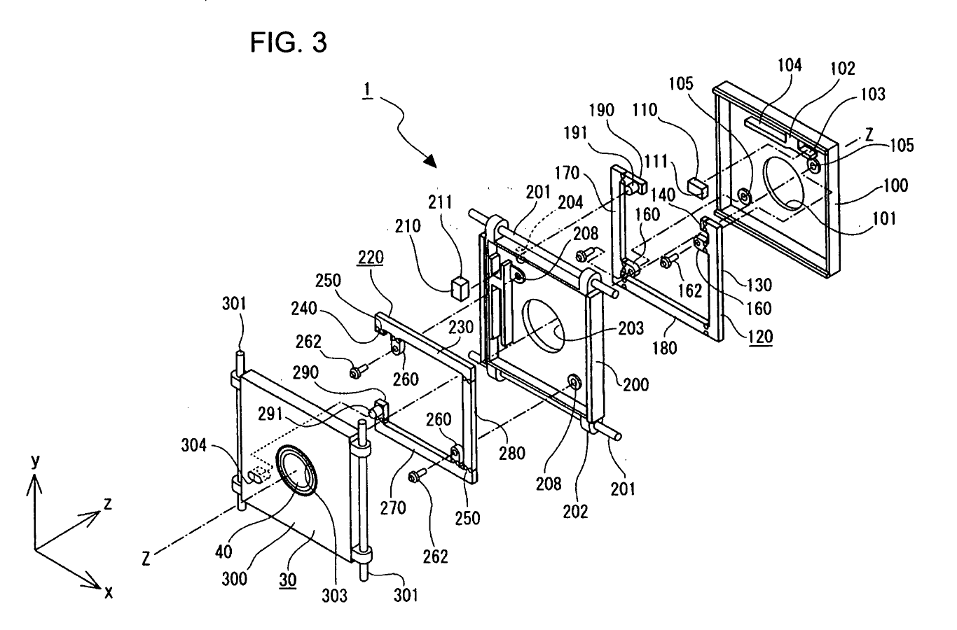

A lens driving mechanism 1 includes three blocks, a stationary block 10, a first movable block 20, and a second movable block 30. The stationary block 10 is fixedly supported at a lens barrel (not shown). The first movable block 20 is movable in one direction perpendicular to an optical axis with respect to the lens barrel, that is, in an X direction with respect to the direction of arrow Z, defined as the optical axis direction, among the directions of arrows X, Y, and Z perpendicular to each other in FIG. 1, and the second movable block 30 is movable in the Y-axis direction perpendicular to the optical axis direction Z and the X-axis direction.

The stationary block 10 has a base table 100 serving as a stationary base. The base table 100 is fixedly supported with respect to the lens barrel.

The first movable block 20 has an X-axis table 200 serving as a first movable base. The first movable block 20 is slidably supported by two guide shafts 201 and 201 disposed so as to extend in the X-axis direction with respect to the lens barrel, and is thus supported so as to be movable in the X-axis direction with respect to the lens barrel. Support portions 202 and 202 protrude from the left and right ends of the upper and lower end surfaces of the X-axis table 200. The guide shafts 201 and 201 are slidably inserted in these support portions 202.

The second movable block 30 includes a Y-axis table 300 serving as a second movable base. The second movable block 30 is slidably supported by two guide shafts 301 and 301 disposed so as to extend in the Y-axis direction with respect to the lens barrel, and is thus supported so as to be movable in the Y-axis direction with respect to the lens barrel. Support portions 302 and 302 protrude from the upper and lower end portions of the left and right ends of the Y-axis table 300. The guide shafts 301 and 301 are slidably inserted in these support portions 302. A correcting lens 40 is mounted to a mounting hole 303 in the center of the Y-axis table 300.

The first movable block 20 moves in the X-axis direction by a link mechanism and an electro-mechanical conversion element disposed at the stationary block 10, whereas the second movable block 30 moves in the Y-axis direction by a link mechanism and an electro-mechanical conversion element disposed at the first movable block 20. Therefore, the correcting lens 40 held by the second movable block 30 moves in all directions perpendicular to the optical axis (Z-axis direction).

The base table 100 of the stationary block 10 has a substantially rectangular plate shape, and has a through hole 101 in the center thereof. In a stationary state, that is, when the electro-mechanical conversion element (described later) is not energized, the through hole 101 is disposed coaxially with the mounting hole 303 in the Y-axis table 300. The through hole 101 has a size large enough to include the entire effective diametrical area of the correcting lens 40 when viewed in the optical axis direction in a state in which the correcting lens 40 is maximally displaced from the optical axis.

An electro-mechanical conversion element 110 which is deformed when an electrical field is applied thereto and a first link mechanism 120 which increases and transmits the deformation of the electro-optical conversion element 110 are disposed at the base table 100. The electro-mechanical conversion element 110 is formed of, for example, piezoelectric ceramic, and may be a single plate type or a multilayer type. The electro-mechanical conversion element used in the embodiment is not limited to that formed of piezoelectric ceramic. In other words, it may be formed of any other material as long as this material is mechanically deformed when an electrical field is applied thereto.

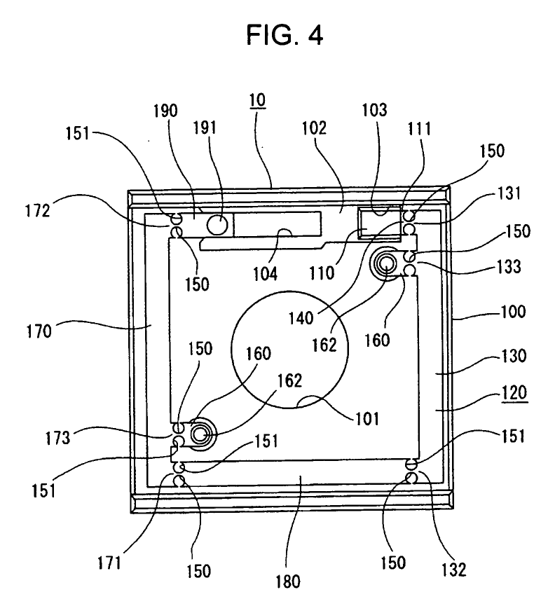

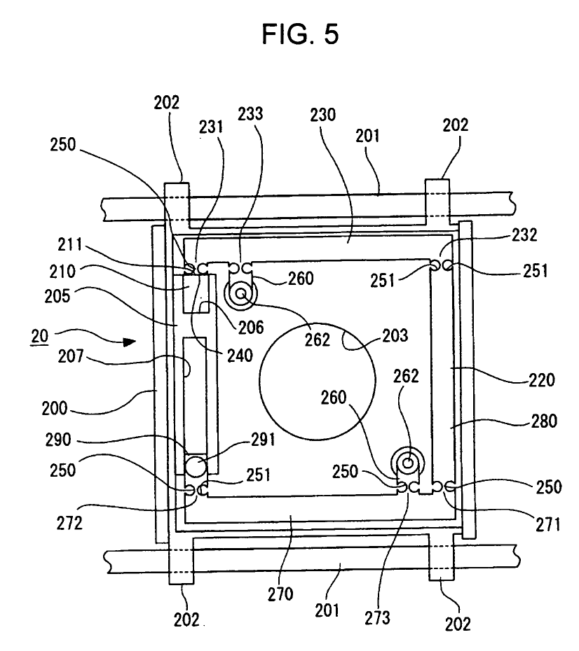

A forwardly protruding protrusion 102 is formed on the upper portion of the front surface of the base table 100 in FIG. 4, and a substantially rectangular recess 103 opening rightwards is formed at the right end portion of the protrusion 102. The electro-mechanical conversion element 110 fitted in the recess 103 is adhered to the base table 100 in a suitable way with, for example, an adhesive. A guide recess 104 extending horizontally and opening leftwards is formed on the left of the protrusion 102.

The first ring mechanism 120 has two levers, three links, and two fulcrum members. When these members are integrally formed and joined with thin integral hinges, these members are formed into one unit.

A power point 131 of a first lever 130 disposed so as to extend substantially vertically at the right front side of the base table 100 is connected to an end 111 of the electro-mechanical conversion element 110 via a first link 140. The first link 140 and the power point 131 of the first lever 130 are integrated, and the first lever 130 and the first link 140 are linked with an integral hinge 150. In other words, cut portions 151 and 151 are formed in both sides of a connecting portion of the first lever 130 and the first link 140, and a thin portion 150 remaining between the two cut portions 151 and 151 is defined as the hinge. Therefore, the first link mechanism 120 has a resiliency which allows it to repeatedly flex by making each member thereof thin, and is such that portions thereof having a certain thickness are integrally formed of synthetic resin having a rigidity allowing reliable transmission of very small displacements. For example, it is desirable that the first link mechanism 120 be formed of resilient thermoplastic resin which is highly resistant to repeated fatigue, such as polyoxymethylene (POM).

The first link 140 and the end 111 of the electro-mechanical conversion element 110 are joined with, for example, an adhesive.

The first lever 130 has a fulcrum 133 between the power point 131 and an application point 132. The fulcrum 133 is positioned closer to the power point 131 than an intermediate point between the power point 131 and application point 132, and is such that the amount of displacement applied to the power point 131 is increased at the application point. The fulcrum 133 is supported at the base table 100 through a fulcrum member 160. A mounting hole 161 is formed in the fulcrum member 160. The fulcrum member 160 and the fulcrum 133 of the first lever 130 are connected with an integral hinge 150. A mounting screw 162 inserted in the mounting hole 161 in the fulcrum member 160 is screwed in a threaded hole 105 formed in the base table 100, so that the fulcrum member 160 is secured to the base table 100. The first lever 130 can tilt as a result of flexing of the integral hinge 150 between the first lever 130 and the fulcrum member 160.

The second lever 170 is disposed opposite to the first lever 130 with the through hole 101 in the base table 100 being disposed therebetween. The second lever 170 has a fulcrum 173 between a power point 171 and an application point 172. The fulcrum 173 is positioned closer to the power point 171 than an intermediate point between the power point 171 and application point 172, and is such that the amount of displacement applied to the power point 171 is increased at the application point. The fulcrum 173 is supported at the base table 100 through a fulcrum member 160. A mounting hole 161 is formed in the fulcrum member 160. The fulcrum member 160 and the fulcrum 173 of the second lever 170 are connected with an integral hinge 150. A mounting screw 162 inserted in the mounting hole 161 in the fulcrum member 160 is screwed in a threaded hole 105 formed in the base table 100, so that the fulcrum member 160 is secured to the base table 100. The second lever 170 can tilt as a result of flexing of the integral hinge 150 between the second lever 170 and the fulcrum member 160.

The application point 132 of the first lever 130 and the power point 171 of the second lever 170 are connected with a second link 180. A connecting portion of the second link 180 and the application point 132 of the first lever 130 and a connecting portion of the second link 180 and the power point 171 of the second lever 170 are connected with integral hinges 150.

The application point 173 of the second lever 170 and the first movable block 20 are linked with a third link 190. The third link 190 is linked to the application point 173 of the second lever 170 with an integral hinge 150. A connecting pin 191 protrudes forwardly from a location closer to an end opposite to a connecting portion of the third link 190 with the second lever 170. The third link 190 is positioned in the guide recess 104 in the base table 100 so that its movement is limited to horizontal directions.

The first movable block 20 is disposed in front of the stationary block 10.

The X-axis table 200 of the first movable block 20 has a substantially rectangular plate shape, that is, has a shape that is the same as that of the base table 100 when viewed in the optical axis direction, and has a through hole 203 in the center thereof. In a stationary state, that is, when the electro-mechanical conversion element (described later) is not energized, the through hole 203 is disposed coaxially with the mounting hole 303 in the Y-axis table 300. The through hole 203 has a size large enough to include the entire effective diametrical area of the correcting lens 40 when viewed in the optical axis direction in a state in which the correcting lens 40 is maximally displaced from the optical axis.

A linking hole 204 is formed in the upper left location in the X-axis table 200 of the first movable block 20 when viewed from the front of the X-axis table 200 of the first movable block 20. The connecting pin 19 at the third link 190 disposed at the stationary block 100 is fitted to the linking hole 204, so that the movement of the third link 190 is transmitted to the X-axis table 200.

An electro-mechanical conversion element 210 which is deformed when an electrical field is applied thereto and a second link mechanism 220 which increases and transmits the deformation of the electro-optical conversion element 210 are disposed at the X-axis table 200. Like the electro-mechanical conversion element 110, the electro-mechanical conversion element 210 is formed of, for example, piezoelectric ceramic, and may be a single plate type or a multilayer type.

A forwardly protruding protrusion 205 is formed on the left portion of the front surface of the X-axis table 200 when viewed in the optical axis direction and in the rearward direction, and a substantially rectangular recess 206 opening rightwards is formed at the upper end portion of the protrusion 205. The electro-mechanical conversion element 210 fitted in the recess 206 is adhered to the X-axis table 200 in a suitable way with, for example, an adhesive. A guide recess 207 extending vertically and opening downwards is formed below the protrusion 205.

The second ring mechanism 220 has two levers, three links, and two fulcrum members. When these members are integrally formed and joined with thin integral hinges, these members are formed into one unit.

A power point 231 of a first lever 230 disposed so as to extend substantially horizontally at the upper front side of the X-axis table 200 is connected to an end 211 of the electro-mechanical conversion element 210 via a first link 240. The first link 240 and the power point 231 of the first lever 230 are integrated, and the first lever 230 and the first link 240 are linked with an integral hinge 250. In other words, cut portions 251 and 251 are formed in both sides of a connecting portion of the first lever 230 and the first link 240, and a thin portion 250 remaining between the two cut portions 251 and 251 is defined as the hinge. Therefore, the first link mechanism 220 has a resiliency which allows it to repeatedly flex by making each member thereof thin, and is such that portions thereof having a certain thickness are integrally formed of synthetic resin having a rigidity allowing reliable transmission of very small displacements. For example, it is desirable that the second link mechanism 220 be formed of resilient thermoplastic resin which is highly resistant to repeated fatigue, such as polyoxymethylene (POM).

The first link 240 and the end 211 of the electro-mechanical conversion element 210 are joined with, for example, an adhesive.

The first lever 230 has a fulcrum 233 between the power point 231 and an application point 232. The fulcrum 233 is positioned closer to the power point 231 than an intermediate point between the power point 231 and application point 232, and is such that the amount of displacement applied to the power point 231 is increased at the application point. The fulcrum 233 is supported at the X-axis table 200 through a fulcrum member 260. A mounting hole 261 is formed in the fulcrum member 260. The fulcrum member 260 and the fulcrum 233 of the first lever 230 are connected with an integral hinge 250. A mounting screw 262 inserted in the mounting hole 261 in the fulcrum member 260 is screwed in a threaded hole 208 formed in the X-axis table 200, so that the fulcrum member 260 is secured to the X-axis table 200. The first lever 230 can tilt as a result of flexing of the integral hinge 250 between the first lever 230 and the fulcrum member 260.

The second lever 270 is disposed opposite to the first lever 230 with the through hole 203 in the X-axis table 200 being disposed therebetween so as to extend substantially horizontally at the lower front portion of the X-axis table 200. The second lever 270 has a fulcrum 273 between a power point 271 and an application point 272. The fulcrum 273 is positioned closer to the power point 271 than an intermediate point between the power point 271 and application point 272, and is such that the amount of displacement applied to the power point 271 is increased at the application point 272. The fulcrum 273 is supported at the X-axis table 200 through a fulcrum member 260. A mounting hole 261 is formed in the fulcrum member 260. The fulcrum member 260 and the fulcrum 273 of the second lever 270 are connected with an integral hinge 250. A mounting screw 262 inserted in the mounting hole 261 in the fulcrum member 260 is screwed in a threaded hole 208 formed in the X-axis table 200, so that the fulcrum member 260 is secured to the X-axis table 200. The second lever 270 can tilt as a result of flexing of the integral hinge 250 between the second lever 270 and the fulcrum member 260.

The application point 232 of the first lever 230 and the power point 271 of the second lever 270 are connected with a second link 280. A connecting portion of the second link 280 and the application point 232 of the first lever 230 and a connecting portion of the second link 280 and the power point 271 of the second lever 270 are connected with integral hinges 250.

The application point 273 of the second lever 270 and the second movable block 30 are linked with a third link 290. The third link 290 is linked to the application point 273 of the second lever 270 with an integral hinge 250. A connecting pin 291 protrudes forwardly from a location closer to an end opposite to a connecting portion of the third link 290 with the second lever 270. The third link 290 is positioned in the guide recess 207 in the X-axis table 200 so that its movement is limited to horizontal directions.

The Y-axis table 300 of the second movable block 30 has a rectangular plate shape that is substantially the same as those of the base table 100 and the X-axis table 200, and has a connecting hole 304 extending horizontally at the lower left portion thereof when viewed in the optical axis direction and in the rearward direction, so as to be slightly longer in the X-axis direction. The connecting pin 291 at the first movable block 20 slidably engages the connecting hole 304, so that the deformation of the electro-mechanical conversion element 210 of the first movable block 20 is increased by the second link mechanism 220 and transmitted to the second movable block 30.

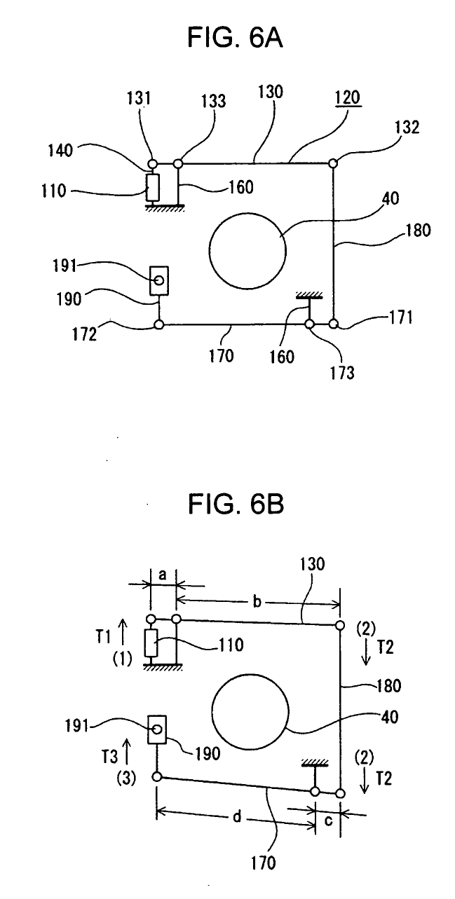

The operation of the lens driving mechanism 1 will be described primarily with reference to FIG. 6.

With the correcting lens 40 being positioned on an optical axis z-z, the mounting screws 162, 162, 262, and 262 securing the respective fulcrum members 160, 160, 260, and 260 are screwed into the respective threaded holes 105, 105, 208, and 208 in order to reliably secure the fulcrum members 160, 160, 260, and 260 to the base table 100 and the X-axis table 200, respectively. In this state, the electro-mechanical conversion element 110 and the electro-mechanical conversion element 210 are secured to the base table 100 and the X-axis table 200, respectively, with, for example, an adhesive. This causes the correcting lens 40 to be positioned on the optical axis z-z when a voltage is not applied to the electro-mechanical conversion elements 110 and 210. In this embodiment, the piezoelectric ceramic used in the electro-mechanical conversion elements 110 and 210 is deformed in proportion to the applied voltage. When the piezoelectric ceramic is deformed, the force for deforming it is large. Even if a considerably large mechanical force is applied, the piezoelectric ceramic is not easily deformed. Therefore, the correcting lens 40 is not deformed merely by the gravity exerted upon, for example, the Y-axis table 300 and the X-axis table 200 holding the correcting lens 40. Consequently, when a voltage is not applied, the correcting lens 40 can be reliably held on the optical axis.

FIG. 6A schematically shows a state in which a voltage is not applied to the electro-mechanical conversion element 110.

When, from the state shown in FIG. 6A, a voltage is applied to the electro-mechanical conversion element 110 in a certain direction, the electro-mechanical conversion element 110 is deformed, so that the end 111 connected to the first link 140 is displaced, for example, in the direction of arrow (1) shown in FIG. 6B by the deformation. The displacement is transmitted to the power point 131 of the first lever 130 through the first link 140, so that the first lever 130 rotates upon the fulcrum 133 as the center, causing the displacement to be transmitted to the application point 132 as an increased displacement in the direction of arrow (2). At this time, the displacement in the direction of arrow (2) occurring at the application point of the first lever 130 is expressed by a ratio b/a, where a is the distance from the power point 131 to the fulcrum and b is the distance from the application point to the fulcrum. In other words, when the displacement amount at the power point 131 is T1, a displacement amount T2 at the application point 132 is equal to T1, that is, T2=T1 (b/a).

The displacement transmitted to the application point 132 of the first lever 130 is transmitted to the power point 171 of the second lever 170 via the second link 180, so that the second lever 170 rotates upon the fulcrum 173 as the center, causing the displacement to be transmitted to the application point 172 as an increased displacement in the direction of arrow (3). At this time, the displacement in the direction of arrow (3) occurring at the application point 172 of the second lever 170 is expressed by a ratio d/c, where c is the distance from the power point 171 to the fulcrum and d is the distance from the application point to the fulcrum. In other words, when the displacement amount at the power point 171 is T2, a displacement amount T3 at the application point 172 is equal to T2, that is, T3=T2 (d/c). Therefore, the displacement amount T1 at the electro-mechanical conversion element 110 is doubled (b·d)/(a·c), and the doubled displacement is transmitted to the connecting pin 191 at the third link 190 from the application point 172 of the second lever 170.

Accordingly, when the connecting pin 191 at the stationary block 10 is moved in the X-axis direction, the X-axis table 200 connected to the connecting pin 191 through the connecting hole 204 is moved in the X-axis direction, so that the Y-axis table 300 connected to the connecting pin 291 at the first movable block 20 through the connecting hole 304 moves in the X-axis direction along with the X-axis table 200.

When a voltage is applied to the electro-mechanical conversion element 210 at the first movable block 20, similarly to the above, the displacement of the electro-mechanical conversion element 210 occurring due to the application of the voltage is increased and transmitted to the connecting pin 291 via the first lever 230 and the second lever 270, so that the second movable block 30 connected to the connecting pin 291 moves in the Y-axis direction with respect to the first movable block 20.

Accordingly, the second movable block 30 holding the correcting lens 40 moves in the X-axis direction and by an amount in accordance with the direction and magnitude of the voltage applied to the electro-mechanical conversion element 110 at the stationary block 10, and moves in the Y-axis direction and by an amount in accordance with the direction and magnitude of the voltage applied to the electro-mechanical conversion element 210 at the first movable block 20. In other words, the correcting lens 40 can move in any direction perpendicular to the optical axis z-z by a predetermined amount.

When a voltage in a direction opposite to that in FIG. 6 is applied to the electro-mechanical conversion element 110 (210), the end 111 of the electro-mechanical conversion element 110 is displaced in a direction opposite to the direction of the arrow (1) shown in FIG. 6B.

In the lens driving mechanism 1, the correcting lens 40 can be reliably positioned on the optical axis without continuing energization, so that power can be saved. In addition, when the user starts to use the camera movement correction function, a sudden change does not occur in the framing, which is desirable for the user. Further, since the correcting lens 40 is reliably held by the electro-mechanical conversion elements 110 and 210, movement of the correcting lens 40 from the optical axis due to inertia produced when, for example, the camera is suddenly subjected to panning rarely occurs.

In the lens driving mechanism 1, the link mechanisms 120 and 220 are disposed around the correcting lens 40 when viewed in the optical axis direction at the outer side of the effective diameter of the correcting lens 40. Therefore, a plurality of levers can be disposed to achieve a large magnification without adversely affecting the largest external shape of the lens barrel.

The members of the link mechanisms 120 and 220 are all integrally formed, and are connected with integral hinges, and the fulcra are supported by the integral hinges. Therefore, very small displacements can be precisely transmitted without any error which occurs as in a connecting structure using a hole and a shaft due to an inevitable difference between the shape of the hole and the shape of the shaft.

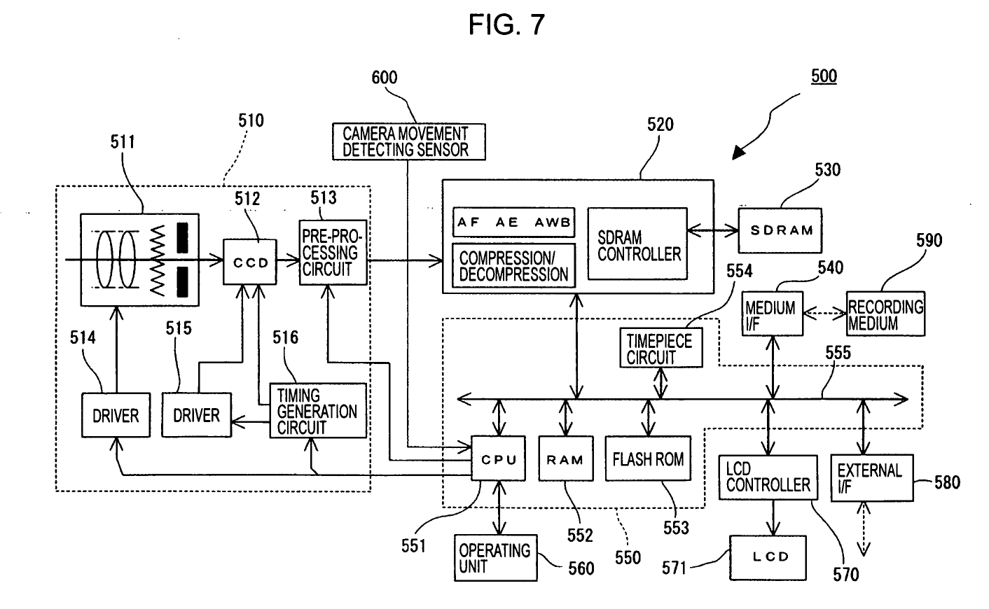

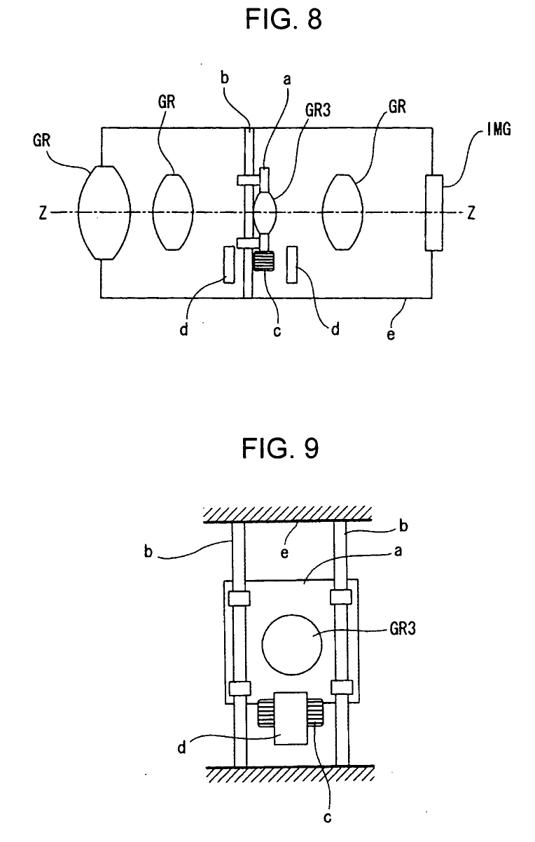

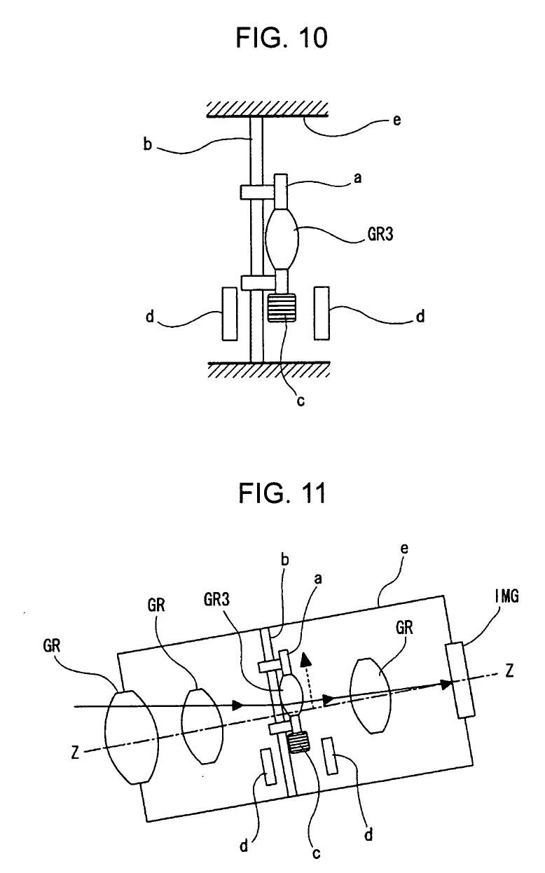

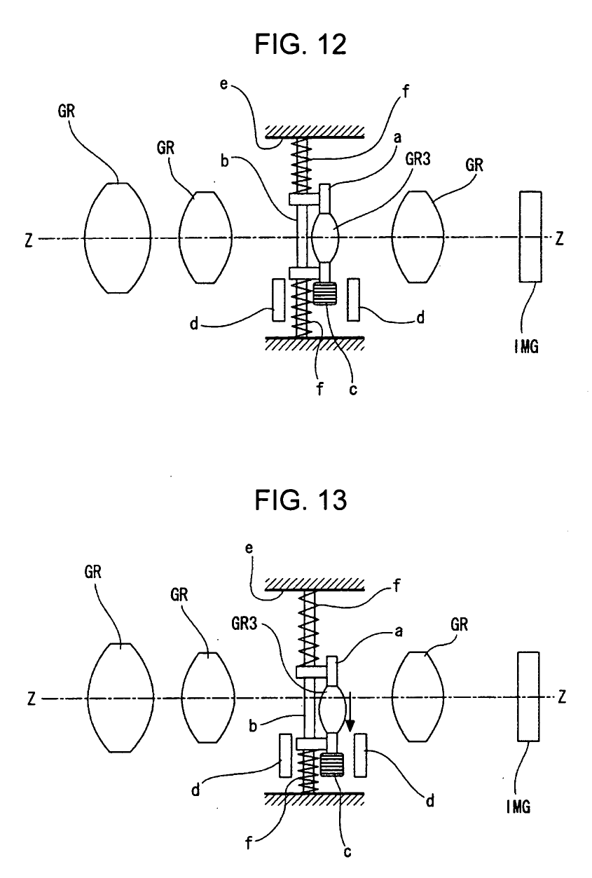

FIG. 7 is a block diagram of an image pickup device according to an embodiment of the present invention.

An image pickup device 500 according to this embodiment broadly includes a camera 510, a camera digital signal processor (camera DSP) 520, a synchronous dynamic random access memory (SDRAM) 530, a medium interface (hereunder referred to as “medium I/F”) 540, a controlling unit 550, an operating unit 560, a liquid crystal display (LCD) controller 570, a liquid crystal display (LCD) 571, and an external interface (hereunder referred to as “external I/F) 580. A recording medium 590 is removable from the image pickup device 500.

Various types of recording media may be used for the recording medium 590. They include what is called a memory card using a semiconductor memory, an optical recording medium such as a recordable compact disc (CD) and a recordable digital versatile disk (DVD), and a magnetic disc. In this embodiment, the recording medium 590 will be described as being a memory card.

The camera 510 includes an optical block 511, a charge coupled device (CCD) 512, a pre-processing circuit 513, an optical block driver 514, a CCD driver 515, and a timing generating circuit 516. Here, the optical block 511 includes, for example, a lens, a focusing mechanism, a shutter mechanism, an iris mechanism, and a camera movement correcting mechanism using the aforementioned lens driving mechanism 1.

The controlling unit 550 is a microcomputer in which a central processing unit (CPU) 551, a random access memory (RAM) 552, a flash read only memory (flash ROM) 553, and a timepiece circuit 554 are connected via a system bus 555. The controlling unit 550 can control each part of the image pickup device according to the embodiment.

Here, RAM 552 is primarily used as a working area, such as an area where a processing result is temporarily stored during a processing operation. The flash ROM 553 stores, for example, data required for a processing operation and various programs executed at the CPU 551. The timepiece circuit 554 can provide, for example, the current date, the current day of the week, the current time, and the date of shooting.

When shooting an image, in accordance with the controlling operation by the controlling unit 550, the optical block driver 514 forms a drive signal for operating the optical block 511. The drive signal is supplied to the optical block 511 in order to operate the optical block 511. The focusing mechanism, the shutter mechanism, the iris mechanism and the camera movement correcting mechanism of the optical block 511 are controlled in accordance with the drive signal from the optical block driver 514 in order to receive a subject image. The subject image is provided to the CCD 512. In the controlling operation on the camera movement correcting mechanism, information regarding the camera movement amount detected by the detecting sensor 600, including, for example, an X-axis direction accelerometer and a Y-axis direction accelerometer, is output to the controlling unit 550. On the basis of the camera movement amount, the controlling unit 550 calculates the amount of shift in the position of the correcting lens 40. Then, the controlling unit 550 controls the driving of a correcting lens position controlling section (not shown) in the optical block driver 514 so as to shift the position of the correcting lens 40 on the basis of the calculated amount of shift. For example, when the position of the correcting lens 40 is controlled with the lens driving mechanism 1 according to the above-described embodiment, the correcting lens position controlling section shifts the position of the correcting lens 40 by applying an electrical field to the electro-mechanical conversion elements 110 and/or 210 of the lens driving mechanism 1 on the basis of a control signal from the controlling unit 550.

The CCD 512 performs photo-electric conversion on the image from the optical block 511 and outputs the converted image. The CCD 512 operates in accordance with a drive signal from the CCD driver 515, receives the subject image from the optical block 511, and supplies to the pre-processing circuit 513 the received subject image (image information) as an electrical signal on the basis of a timing signal from the timing generating circuit 516 controlled by the controlling unit 550.

As mentioned above, the timing generating circuit 516 forms a timing signal (which provides a predetermined timing) in accordance with the controlling by the controlling unit 550. On the basis of the timing signal from the timing generating circuit 516, the CCD driver 515 forms the drive signal which is supplied to the CCD 512.

The pre-processing circuit 513 maintains a proper S/N ratio by performing correlated double sampling (CDS) in accordance with the image information of the electrical signal supplied to the pre-processing circuit 513. The pre-processing circuit 513 also controls gain by performing automatic gain control (AGC), and forms image data of a digital signal by performing analog/digital (A/D) conversion.

The image data of the digital signal from the pre-processing circuit 513 is supplied to the camera DSP 520. The camera DSP 520 performs camera signal processing operations, such as auto focus (AF), auto exposure (AE), and auto white balance (AWB) on the supplied image data. The image data variously adjusted in this manner is compressed by a predetermined compression method, and the compressed image data is supplied to the recording medium 590 loaded in the image pickup device according to the embodiment via the system bus 555 and the medium I/F 540 in order to be recorded as a file on the recording medium 590.

The image data to be read recorded on the recording medium 590 is read from the recording medium 590 via the medium I/F 540 in accordance with a user's input accepted via the operating unit 560 including, for example, a touch panel and a control key. Then, the read image data is supplied to the camera DSP 520.

The camera DSP 520 decompresses the compressed image data read from the recording medium 590 and supplied via the medium I/F 540. Then, the decompressed image data is supplied to the LCD controller 570 via the system bus 555. The LCD controller 570 forms an image signal to be supplied the LCD 571 on the basis of the supplied image data, and supplies the image signal to the LCD 571. This causes an image formed in accordance with the image data recorded on the recording medium 590 to be displayed on a display screen of the LCD 571.

The form of the display of the image is in accordance with a display processing program recorded in ROM. The display processing program is a program for indicating by what mechanism a file system (described later) is recorded and how an image is reproduced.

The image pickup device 500 according to the embodiment includes the external I/F 580. The image pickup device 500 may be connected to, for example, an external personal computer via the external I/F 580 in order to receive image data from the personal computer and record the supplied image data onto the recording medium 590 loaded in the image pickup device 500 and in order to supply the image data recorded on the recording medium 590 loaded in the image pickup device 500 to the external personal computer.

Connecting the image pickup device 500 to a network, such as the internet, by connecting a communication module to the external I/F 580 makes it possible to obtain various image data and other types of data through the network in order to record such data on the recording medium 590 loaded in the image pickup device 500 and to transmit the data recorded on the recording medium 590 loaded in the image pickup device 500 to a target device via the network.

Obviously, data, such as image data, obtained via the external personal computer or network and recorded on the recording medium 590 may be read out and reproduced at the image pickup device 500 and displayed on the LCD 571 for use by a user.

The external I/F 580 may be disposed as a wired interface, such as Institute of Electrical and Electronics Engineers (IEEE) 1394 or a universal serial bus (USB), or as a wireless interface based on light or electrical waves.

Accordingly, the image pickup device 500 can shoot a subject image and record the subject image on the recording medium 590, and can read out the image data recorded on the recording medium 590, reproduce the read image data, and use the reproduced image data. In addition, through an external personal computer or a network, the image pickup device 500 can receive image data and record the image data on the recording medium 590 loaded in the image pickup device 500 or read out and reproduce the recorded image data.

The form and structure of each part in each of the embodiments are merely examples in embodying the present invention when carrying out the present invention. Therefore, these are not to be construed as limiting the technical scope of the present invention.

1. A lens driving mechanism for eccentrically driving at least one lens or lens subunit, hereunder called a correcting lens, in a lens system constituting a taking lens unit in a plane perpendicular to an optical axis direction, the lens driving mechanism comprising:
an electro-mechanical conversion element fixedly disposed at a lens barrel where the taking lens unit is disposed, the electro-mechanical conversion element being mechanically deformed by an application of a voltage; and
a link mechanism increasing the mechanical deformation of the electro-mechanical conversion element and transmitting the increased mechanical deformation to the correcting lens,
wherein the link mechanism is disposed around the correcting lens at the outer side of an effective diameter of the correcting lens when viewed in the optical axis direction.

2. The lens driving mechanism according to claim 1, wherein the link mechanism includes at least one lever including a first lever and having a fulcrum, a power point, and an application point, and the mechanical deformation of the electro-mechanical conversion element connected to the power point of the first lever is increased and transmitted to the application point of the first lever.

3. The lens driving mechanism according to claim 2, wherein the at least one lever of the link mechanism further includes a second lever having a fulcrum, a power point, and an application point, the power point of the second lever is connected to the application point of the first lever, and the first lever and the second lever are disposed opposite to each other with the correcting lens being disposed therebetween when viewed in the optical axis direction.

4. The lens driving mechanism according to claim 1, wherein members of the link mechanism are integrally disposed and are connected with an integral hinge corresponding to a thin connecting portion of the members of the link mechanism.

5. The lens driving mechanism according to claim 2, wherein the link mechanism further includes a link linking the first lever and the electro-mechanical conversion element, and the link and the power point of the first lever are integrally disposed and are connected with a thin integral hinge.

6. The lens driving mechanism according to claim 3, wherein the link mechanism further includes a first link linking the first lever and the electro-mechanical conversion element and a second link linking the application point of the first lever and the power point of the second lever, and the first link and the power point of the first lever, the second link and the application point of the first lever, and the second link and the power point of the second lever are integrally disposed and are connected with thin integral hinges, respectively.

7. A lens driving mechanism for eccentrically driving at least one lens or lens subunit, hereunder called a correcting lens, in a lens system constituting a taking lens unit in a plane perpendicular to an optical axis direction, the lens driving mechanism comprising:
a stationary base fixedly disposed at a lens barrel where the taking lens unit is disposed;
a first movable base movable in one direction perpendicular to the optical axis direction with respect to the stationary base; and
a second movable base movable perpendicularly to the optical axis direction and the one direction with respect to the first movable base,
wherein the stationary base and the first movable base each have an electro-mechanical conversion element and a link mechanism disposed thereat, each electro-mechanical conversion element being fixedly disposed at its associated base and being mechanically deformed by an application of a voltage, each link mechanism being disposed around the correcting lens at the outer side of an effective diameter of the correcting lens when viewed in the optical axis direction and increasing and transmitting the mechanical deformation of its associated electro-mechanical conversion element,
wherein the mechanical deformation of the electro-mechanical conversion element disposed at the stationary base is transmitted to the first movable base by the link mechanism disposed at the stationary base,
wherein the mechanical deformation of the electro-mechanical conversion element disposed at the first movable base is transmitted to the second movable base by the link mechanism disposed at the first movable base, and
wherein the second movable base holds the correcting lens.

8. The lens driving mechanism according to claim 7, wherein each link mechanism includes at least one lever including a first lever and having a fulcrum, a power point, and an application point, and the mechanical deformation of each electro-mechanical conversion element connected to the power point of its associated first lever is increased and transmitted to the application point of its associated first lever.

9. The lens driving mechanism according to claim 8, wherein the at least one lever of each link mechanism further includes a second lever having a fulcrum, a power point, and an application point, the power point of each second lever is connected to the application point of its associated first lever, and each first lever and its associated second lever are disposed opposite to each other with the correcting lens being disposed therebetween when viewed in the optical axis direction.

10. The lens driving mechanism according to claim 7, wherein members of each link mechanism are integrally disposed and are connected with an integral hinge corresponding to a thin connecting portion of the members of its associated link mechanism.

11. The lens driving mechanism according to claim 8, wherein each link mechanism further includes a link linking its associated first lever and its associated electro-mechanical conversion element, and each link and the power point of its associated first lever are integrally disposed and are connected with a thin integral hinge.

12. The lens driving mechanism according to claim 9, wherein each link mechanism further includes a first link linking its associated first lever and its associated electro-mechanical conversion element and a second link linking the application point of its associated first lever and the power point of its associated second lever, and each first link and the power point of its associated first lever, each second link and the application point of its associated first lever, and each second link and the power point of its associated second lever are integrally disposed and are connected with thin integral hinges, respectively.

13. An image pickup device comprising:
a taking lens unit;
an image pickup element converting an optical image formed by the taking lens unit into an electrical signal; and
a lens driving mechanism for eccentrically driving at least one lens or lens subunit, hereunder called a correcting lens, in a lens system constituting the taking lens unit in a plane perpendicular to an optical axis direction,
wherein the lens driving mechanism includes an electro-mechanical conversion element fixedly disposed at a lens barrel where the taking lens unit is disposed, the electro-mechanical conversion element being mechanically deformed by an application of a voltage, and a link mechanism increasing the mechanical deformation of the electro-mechanical conversion element and transmitting the increased mechanical deformation to the correcting lens, and
wherein the link mechanism is disposed around the correcting lens at the outer side of an effective diameter of the correcting lens when viewed in the optical axis direction.

14. The image pickup device according to claim 13, wherein the link mechanism includes at least one lever including a first lever and having a fulcrum, a power point, and an application point, and the mechanical deformation of the electro-mechanical conversion element connected to the power point of the first lever is increased and transmitted to the application point of the first lever.

15. The image pickup device according to claim 14, wherein the at least one lever of the link mechanism further includes a second lever having a fulcrum, a power point, and an application point, the power point of the second lever is connected to the application point of the first lever, and the first lever and the second lever are disposed opposite to each other with the correcting lens being disposed therebetween when viewed in the optical axis direction.

16. The image pickup device according to claim 13, wherein members of the link mechanism are integrally disposed and are connected with an integral hinge corresponding to a thin connecting portion of the members of the link mechanism.

17. The image pickup device according to claim 14, wherein the link mechanism further includes a link linking the first lever and the electro-mechanical conversion element, and the link and the power point of the first lever are integrally disposed and are connected with a thin integral hinge.

18. The image pickup device according to claim 15, wherein the link mechanism further includes a first link linking the first lever and the electro-mechanical conversion element and a second link linking the application point of the first lever and the power point of the second lever, and the first link and the power point of the first lever, the second link and the application point of the first lever, and the second link and the power point of the second lever are integrally disposed and are connected with thin integral hinges, respectively.

19. An image pickup device comprising:
a taking lens unit;
an image pickup element converting an optical image formed by the taking lens unit into an electrical signal; and
a lens driving mechanism for eccentrically driving at least one lens or lens subunit, hereunder called a correcting lens, in a lens system constituting the taking lens unit in a plane perpendicular to an optical axis direction,
wherein the lens driving mechanism includes a stationary base fixedly disposed at a lens barrel where the taking lens unit is disposed, a first movable base movable in one direction perpendicular to the optical axis direction with respect to the stationary base, and a second movable base movable perpendicularly to the optical axis direction and the one direction with respect to the first movable base,
wherein the stationary base and the first movable base each have an electro-mechanical conversion element and a link mechanism disposed thereat, each electro-mechanical conversion element being fixedly disposed at its associated base and being mechanically deformed by an application of a voltage, each link mechanism being disposed around the correcting lens at the outer side of an effective diameter of the correcting lens when viewed in the optical axis direction and increasing and transmitting the mechanical deformation of its associated electro-mechanical conversion element,
wherein the mechanical deformation of the electro-mechanical conversion element disposed at the stationary base is transmitted to the first movable base by the link mechanism disposed at the stationary base,
wherein the mechanical deformation of the electro-mechanical conversion element disposed at the first movable base is transmitted to the second movable base by the link mechanism disposed at the first movable base, and
wherein the second movable base holds the correcting lens.

20. The image pickup device according to claim 19, wherein each link mechanism includes at least one lever including a first lever and having a fulcrum, a power point, and an application point, and the mechanical deformation of each electro-mechanical conversion element connected to the power point of its associated first lever is increased and transmitted to the application point of its associated first lever.

21. The image pickup device according to claim 20, wherein the at least one lever of each link mechanism further includes a second lever having a fulcrum, a power point, and an application point, the power point of each second lever is connected to the application point of its associated first lever, and each first lever and its associated second lever are disposed opposite to each other with the correcting lens being disposed therebetween when viewed in the optical axis direction.

22. The image pickup device according to claim 19, wherein members of each link mechanism are integrally disposed and are connected with an integral hinge corresponding to a thin connecting portion of the members of its associated link mechanism.

23. The image pickup device according to claim 20, wherein each link mechanism further includes a link linking its associated first lever and its associated electro-mechanical conversion element, and each link and the power point of its associated first lever are integrally disposed and are connected with a thin integral hinge.

24. The image pickup device according to claim 21, wherein each link mechanism further includes a first link linking its associated first lever and its associated electro-mechanical conversion element and a second link linking the application point of its associated first lever and the power point of its associated second lever, and each first link and the power point of its associated first lever, each second link and the application point of its associated first lever, and each second link and the power point of its associated second lever are integrally disposed and are connected with thin integral hinges, respectively.
